(19) United States
(12) Patent Application Publication
(10) Pub. No.: US 2023/0359021 A1
(43) Pub. Date: Nov. 9, 2023

(54) LASER TARGET SUPER PRECISION SCAN SPHERE

(71) Applicant: Black Knight Enterprises, LLC d/b/a Hubbs Machine, St. Louis, MO (US)

(72) Inventor: Charles Graham, St. Louis, MO (US)

(21) Appl. No.: 18/021,941

(22) PCT Filed: Aug. 23, 2021
(86) PCT No.: PCT/US2021/047188

§ 371 Date: Feb. 17, 2023

Related U.S. Application Data
(60) Provisional application No. 63/069,386, filed on Aug. 24, 2020.

(51) Int. Cl. G02B 26/10; G02B 5/12

(52) U.S. Cl. CPC G02B 26/10; G02B 5/12

(57) ABSTRACT

The invention is directed to a target in the form of a super precision scan sphere that can be utilized in existing systems having smaller scan spheres. The present scan sphere has an interior chamber and can be placed over an existing sphere. A magnet in the interior chamber can be used to adhere the scan sphere to the smaller existing sphere.

### CROSS-REFERENCE TO RELATED APPLICATIONS

The present invention claims priority to and the benefit of U.S. Provisional Patent Application No. 63/069,386 filed Aug. 24, 2020, the contents of which are incorporated herein by reference and made a part hereof.

### FEDERALLY SPONSORED RESEARCH OR DEVELOPMENT

N/A

### FIELD OF THE INVENTION

The present invention is directed to a scanning target in the form of a super precision scan sphere (“SPSS”) used to measure an exact location with a scanning system (i.e., a scanning technology, such as laser scanning). The scan sphere has an interior chamber and can be placed over a smaller sphere used in the scanning system to provide a target with the same center point as the smaller sphere, but having a greater surface area for more precise measurements.

### DESCRIPTION OF THE PRIOR ART

One known precision scan sphere (“PSS”) is described in U.S. Pat. No. 8,503,053 (“the '053 patent”), having a common inventor with the present application. The sphere in the '053 patent includes a lower insert (reference “4”) or a shank (9) to connect the PSS directly to a mount. Although not specifically identified in the '053 patent, the scanning sphere described therein is believed to provide a scanning tolerance on the order of +/−10 thousandths of an inch.

Typically, in order to replace a smaller sphere with one having a larger radius and surface area, the smaller sphere needs to be removed and a larger sphere having the same or similar mounting structure needs to be placed on the mount. Accordingly, the larger sphere would typically need to originate from the same manufacturer to assure consistency in the mounting structure. The present scan sphere can be used with any system regardless of where it was made.

The present invention provides an improved scan sphere that can provide increased precision and can be easily utilized with existing systems.

### SUMMARY OF THE INVENTION

The present invention is directed to a scan target that can be utilized with existing systems. The target of the present invention is in the form of a super precision scan sphere having a hollow interior portion. The super precision scan sphere has a larger surface area than typical scan spheres (that have been used in the past) and can be easily and quickly secured to a smaller scan sphere to provide enhanced accuracy in a scanning system. This can be done while maintaining the same center point as the smaller scan sphere. The scan sphere of the present invention can be secured to the smaller sphere, for example, by a magnet in the interior portion of the scan sphere.

In accordance with one aspect of the invention, a super precise laser target is provided that can be used with existing systems without removing the prior target. The laser target comprises a scan sphere having a first outer spherical surface and a hollow interior portion. The scan sphere can be placed over the existing target such that the existing target is in the interior portion of the scan sphere. The scan sphere also includes a magnet positioned in the interior portion to secure the scan sphere to the existing sphere.

The magnet can be secured to a top portion of the interior portion. Alternatively, the magnet can be secured at locations in the interior portion or about the scan sphere. More than one magnet spaced at different locations can also be used.

The interior portion of the scan sphere can include a first chamber configured to fit over another sphere having a second outer spherical surface smaller than the first outer spherical surface and a second chamber for securing the magnet. The first chamber can be generally cylindrical. Similarly, the second chamber can be generally cylindrical. Alternatively, the chambers can other shapes. The first chamber is typically larger than the second chamber holding the magnet. The interior portion has a lower opening, preferably a circular opening.

The scan sphere can be formed from anodized aluminum. Additionally, the first spherical surface of the scan sphere can be textured. The scan sphere can have a scanning tolerance of +/−2-3 thousandths of an inch.

In accordance with another aspect of the invention, a scanning target for use with existing systems is provided. The scanning target comprises a scanning sphere having an outer spherical scanning surface and an interior chamber configured to fit over another sphere having a surface smaller than the spherical scanning surface of the scanning sphere.

The scan sphere can include a magnet in the interior chamber for adhering the scan sphere to the another sphere. Alternatively, the scan sphere can include foam, or other similar material, in the interior chamber for providing a snug fit over the another sphere. In another alternative, the scan sphere can include compressible fingers in the interior chamber for providing a snug fit over the another sphere. Specifically, the fingers can be biased in a closed configuration and flex outward over the another sphere when placed on an existing system. Additionally, other structures can be used to secure the scan sphere to the existing system.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of a scan sphere on a mount in accordance with an aspect of the present invention;

FIG. 2 is top perspective view of the scan sphere of FIG. 1 removed from the mount and positioned upside down;

FIG. 3 is lower perspective view of the scan sphere of FIG. 1;

FIG. 4 is a perspective view of a scan sphere in accordance with the present invention with interior features shown in phantom;

FIG. 5 is a side view of the scan sphere of FIG. 4 with a phantom view of an interior sphere the present scan sphere is placed over; and,

FIG. 6 is a bottom view of the scan sphere of FIG. 4.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The SPSS of the present invention can be positioned over a smaller sphere connected to a mount in a scanning system. The SPSS has a hollow interior that fits over the smaller sphere.

One or more magnets in the SPSS can be used to allow the SPSS to adhere to the smaller sphere. In one example, a magnet can be placed proximate the top of the interior of the SPSS to contact the top of the smaller sphere. Other means, such as a compressible foam material, or other interior structure in the SPSS can be used to connect it to the smaller sphere.

Preferably, the SPSS is made from an anodized aluminum and has a textured outer surface. The SPSS can provide a scanning tolerance of +/−2-3 thousandths of an inch.

In some instances, the SPSS can include structure to allow it to connect directly to a mount in the absence of a smaller sphere being connected to the mount.

The SPSS is used for accurate feature locations. Some scan spheres are used for general reference points in space but they do not measure features or points, they are reference points to connect scans together. The SPSS is used to measure an exact location for a laser scanner or any scanning technology. The SPSS is a target used in the same manner other targets are used for a particular metrology system. For example, SMR/BMR to the Laser tracker or a photogrammetry target to a photogrammetry system. An SPSS allows a Laser Scanner to measure the same points as other metrology systems, especially when a sphere mount is used.

The SPSS can be made out of any material, but is preferably formed from aluminum that is anodized.

The SPSS can be any outside diameter.

The SPSS can be made to work with any sphere mount nest, for example 0.500″, 0.875″, 1.500″ nest.

Other mounting options can be incorporated into the SPSS.

The surface of the SPSS must be conducive to scanning

The SPSS is configured with a hollow interior portion so that it fits over a (smaller) spherical item (of a scanning system) to create a larger diameter and greater surface area to be scanned while keeping the same center point.

The SPSS can be made to mount to any size sphere/spherical item and shares the same center point as the sphere/spherical item for the scanner. The SPSS turns the sphere/spherical item into a scan sphere. The SPSS is effective for creating transparencies between laser scanning and other metrology systems.

The SPSS can mount to the sphere/spherical item by any means including but not limited to a magnet, a bonding agent, fastening with a thread or screw, pressed on, etc.

One specific spherical item that the SPSS is designed to fit on is a Spherically Mounted Retroreflector (SMR) used for a Laser Tracker.

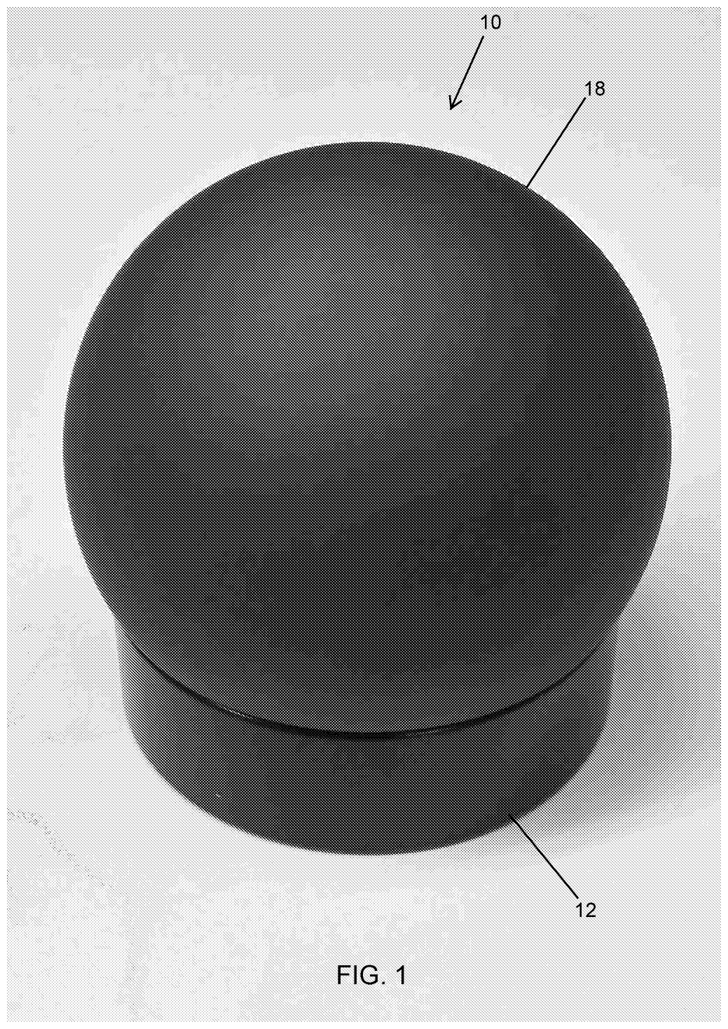

Referring to FIG. 1, a scanning system target, in the form of a scan sphere 10 is shown in accordance with present invention. The scan sphere 10 is shown positioned on a mount 12.

As illustrated in FIG. 2, the scan sphere 10 (shown removed from the mount 12 and upside down) has a hollow interior portion or chamber 14. The interior portion 14 allows the scan sphere 10 to be placed over a smaller sphere 16 (shown positioned on the mount 12) and maintain a same center point as the smaller sphere 16. The scan sphere 10 has a spherical outer surface 18 that is greater than the outer surface 20 of the smaller sphere 16. In this manner, the scan sphere 10 of the present invention can be used to modify known systems to provide a sphere allowing for increased accuracy.

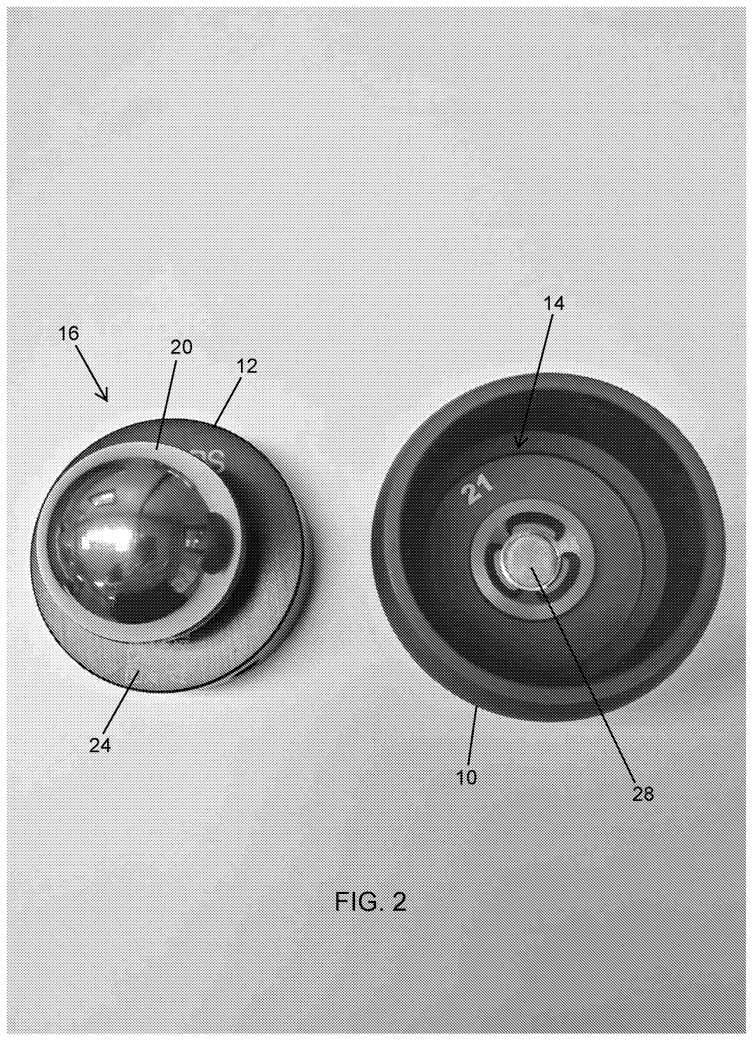

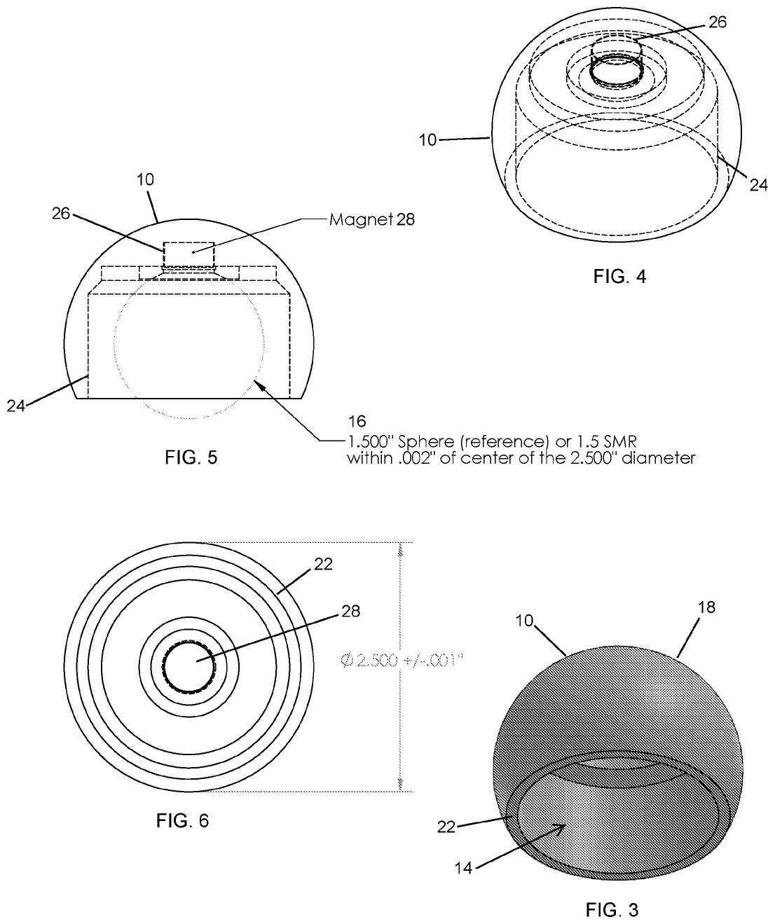

As also shown in FIG. 3, the scan sphere 10 has a bottom ring portion 22 having a flat bottom surface spanning the thickness of the scan sphere 10. The bottom ring portion 22 forms an opening for the interior portion 14. The flat surface of the bottom ring portion 22 contacts a top surface 24 of the mount 12 when the scan sphere 10 is placed over the smaller sphere 16.

As illustrated in phantom in FIGS. 4 and 5, the interior portion 14 of the scan sphere 10 is sized to fit over an existing smaller sphere 16 or other smaller target of a scanning system. The interior portion 14 is shown having a first large, generally cylindrical chamber 24, and a second, smaller generally cylindrical chamber 26 above the first chamber 24.

The first, larger chamber 24 encloses the smaller sphere 16 when the scan sphere 10 is positioned on the mount 12. The second chamber 26 has an opening at the top of the first chamber and is designed to hold a magnet 28 (shown in FIG. 2). The magnet 28 is used to secure the scan sphere 10 to the smaller sphere 16 which is typically formed from a metallic material. While the magnet 28 is shown positioned in a top portion of the interior portion 14, it can be located at other positions. Moreover, more than one magnet can be included in the interior portion 14 at different locations.

The side view of FIG. 5 illustrates the position of the smaller sphere 16 with the scan sphere 10 of the present invention positioned over it (while shown as a complete circle or sphere for illustrative purposes in this Figure, a typical smaller sphere will have some form of anchor or connector at the bottom portion for connecting the smaller sphere to the mount). As shown in FIG. 5, the bottom of the magnet 28 rests against the top of the smaller spherel6 and securely adheres the larger sphere 10 to the smaller sphere 16. As noted, the magnet 28 can also be located at different positions in the scan sphere 10, and more than one magnet 28 can used as needed.

Many modifications and variations of the present invention are possible in light of the above teachings. It is, therefore, to be understood within the scope of the appended claims the invention may be protected otherwise than as specifically described.

I claim:

1. A laser target comprising:
a scan sphere having a first outer spherical surface and a hollow interior portion; and,
a magnet positioned in the interior portion.

2. The laser target of claim 1 wherein the magnet is secured to a top portion of the interior portion.

3. The laser target of claim 1 wherein the interior portion includes a first chamber configured to fit over another sphere having a second outer spherical surface smaller than the first outer spherical surface and a second chamber for securing the magnet.

4. The laser target of claim 3 wherein the first chamber is generally cylindrical.

5. The laser target of claim 4 wherein the second chamber is generally cylindrical

6. The laser target of claim 5 wherein the first chamber is larger than the second chamber.

7. The laser target of claim 1 wherein the interior portion has a lower opening.

8. The laser target of claim 7 wherein the lower opening is circular.

9. The laser target of claim 1 wherein the scan sphere is formed from anodized aluminum.

10. The laser target of claim 1 wherein the first spherical surface of the scan sphere is textured.

11. The laser target of claim 1 wherein the scan sphere has a scan tolerance of +/−2-3 thousandths of an inch.

12. A scanning target comprising:
a scan sphere having an outer spherical scanning surface and an interior chamber configured to fit over another sphere having a surface smaller than the spherical scanning surface of the scan sphere.

13. The scanning target of claim 12 further comprising a magnet in the interior chamber for adhering the scan sphere to the another sphere.

14. The scanning target of claim 12 further comprising foam in the interior chamber for providing a snug fit over the another sphere.

15. A scanning target of claim 12 comprising a plurality of compressible fingers in the interior chamber for providing a snug fit over the another sphere.

16. The scanning target of claim 12 comprising adhesive in the interior chamber for adhering the scan sphere to the another sphere.

17. The scanning target of claim 13 wherein the magnet is in a top portion of the interior chamber of the scan sphere.

18. The scanning sphere of claim 12 wherein the scan sphere is formed from aluminum.

19. The scanning sphere of claim 12 wherein the outer spherical surface of the scan sphere is textured.

20. The scanning sphere of claim 12 wherein the scan sphere has a scanning tolerance of +/−2-3 thousandths of an inch.
